(19) United States
(12) Patent Application Publication
(10) Pub. No.: US 2025/0122827 A1
(43) Pub. Date: Apr. 17, 2025

(54) GENERATOR SOUND ATTENUATION AND SYSTEM THEREOF

(71) Applicant: NORTHERN TOOL & EQUIPMENT COMPANY, INC., Burnsville, MN (US)

(72) Inventors: Matthew R. Pilcher, Owatonna, MN (US); John Schuetz, Owatonna, MN (US)

(21) Appl. No.: 18/912,728

(22) Filed: Oct. 11, 2024

Related U.S. Application Data
(60) Provisional application No. 63/589,368, filed on Oct. 11, 2023.

(51) Int. Cl. F02B 77/13; F02B 63/04

(52) U.S. Cl. CPC F02B 77/13; F02B 63/048; F02B 2063/045

(57) ABSTRACT

A generator includes a frame defining a plurality of sides, an engine, an alternator operably coupled to the engine, a muffler fluidly connected to an exhaust of the engine, a panel coupled to the frame, the panel enclosing a first side of the plurality of sides, and a sound-reducing material coupled to the panel, the sound-reducing material positioned between the panel and the engine.

### FIELD OF THE DISCLOSURE

This application claims the benefit of U.S. Provisional Patent Application Ser. No. 63/589,368, filed Oct. 11, 2023, the disclosure of which is hereby incorporated by reference in its entirety.

### FIELD OF THE DISCLOSURE

The present disclosure relates to portable electric generators, and more particularly to a noise reducing open-frame electric generator.

### BACKGROUND

Portable electric generators produce electric power to function as a power source for a variety of situations. Components of electric generators may cause high noise levels for a user. Thus, there is a desire for an improved noise reducing open-frame electric generator.

### SUMMARY

In one implementation of the present disclosure, a generator includes a frame formed by a plurality of sides including at least a first side, a second side, a third side, and a fourth side; an engine coupled to the frame; an alternator operably coupled to the engine; a muffler fluidly connected to an exhaust of the engine; a panel coupled to the frame, the panel enclosing the first side of the plurality of sides of the frame, where at least one of the second side, third side, and fourth side are open to a surround environment; and foam coupled to the panel, the foam positioned between the panel and the engine.

In one example of this implementation, the foam is sound attenuating foam. In a second example, the panel includes a control panel configured to control the operation of the generator. In a third example, control panel foam is coupled to a housing of the control panel, the control panel foam configured to separate the control panel from at least the engine. In a fourth example, the control panel foam is at least partially wrapped in foil.

In a fifth example, a battery is electrically coupled to the control panel. In a sixth example, a fuel tank is fluidly coupled to the engine. In a seventh example, the fuel tank at least partially encloses the second side of the plurality of sides. In an eighth example, the frame includes a first frame unit, a second frame unit, and a crossbar, the crossbar being coupled between the first frame unit and the second frame unit. In a ninth example, the first frame unit includes at least a first horizontal member, a second horizontal member, a first vertical member, a second vertical member, and a first crossbar; wherein, the second frame unit includes at least a third horizontal member, a fourth horizontal member, a third vertical member, a fourth vertical member, and a second crossbar. In a tenth example, the first frame unit is formed in a first plane and the second frame unit is formed in a second plane, where the first plane and second plane are generally parallel to one another.

In another example, the panel is coupled to either the first frame unit or the second frame unit. In yet another example, the panel includes a side panel, a cover panel, and a filler panel. In a further example, the panel includes an internal side and an exterior side, where the foam is coupled to the internal side of the panel.

In another implementation of the present disclosure, a portable generator configured for generating electrical power includes a frame formed by a plurality of sides including at least a first side, a second side, a third side, and a fourth side of the frame; an internal cavity defined by the frame, the internal cavity forming at least a first region, a second region, a third region, and a fourth region; an engine coupled to the frame and located in the first region; an alternator operably coupled to the engine, the alternator located in the second region; a muffler fluidly connected to an exhaust of the engine, the muffler located in the third region; a battery electrically coupled to a control panel, the battery located in the fourth region; a panel coupled to the frame, the panel enclosing the first side of the plurality of sides of the frame, where at least one of the second side, third side, and fourth side is open to a surrounding environment; and foam coupled to the panel, wherein at least a portion of the foam is positioned between the panel and the engine, the alternator, the battery, and the muffler; wherein, the first region is disposed near the second side of the frame and the second region is disposed near the third side of the frame, where the second side is located on an end of the frame opposite the third side.

In one example of this implementation, the third region is located adjacent the first side of the frame and the fourth region is located adjacent the fourth side of the frame, the first side being opposite the fourth side. In a second example, a heat shield is disposed between the control panel and the engine. In a third example, the frame includes a first frame unit, a second frame unit, and a crossbar, the crossbar being coupled between the first frame unit and the second frame unit. In a fourth example, the first frame unit includes at least a first horizontal member, a second horizontal member, a first vertical member, a second vertical member, and a first crossbar; wherein, the second frame unit includes at least a third horizontal member, a fourth horizontal member, a third vertical member, a fourth vertical member, and a second crossbar.

In a further implementation of the present disclosure, a portable generator configured for generating electrical power includes a frame formed by a plurality of sides including at least a first side, a second side, a third side, and a fourth side of the frame; a wheel assembly coupled to the frame, the wheel assembly including one or more wheels; an internal cavity defined by the frame; an engine coupled to the frame and configured to produce mechanical power; an alternator operably coupled to the engine; a muffler fluidly connected to an exhaust of the engine; a panel coupled to the frame, the panel enclosing the first side of the plurality of sides of the frame; and foam coupled to the panel, wherein at least a portion of the foam is positioned between the panel and the engine; wherein, the panel comprises a side panel, a cover panel, and a filler panel; wherein, the foam comprises a control panel foam, a filler panel foam, and a cover panel foam; wherein, at least one of the second side, third side, and fourth side is open to a surrounding environment.

In one example of this implementation, a control panel is coupled to the frame, the control panel including a starting mechanism configured to start the engine; a display configured to display information about the generator; a plurality of electrical outlets; and a charging port; wherein, the control panel is electrically coupled to a battery, the battery being located within the internal cavity of the frame.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a front right perspective view of a portable generator;

FIG. 2 is a front left perspective view of the portable generator of FIG. 1;

FIG. 3 is a front view of the portable generator of FIG. 1;

FIG. 4 is a rear left perspective view of the portable generator of FIG. 1;

FIG. 5 is a schematic of a top view of the portable generator of FIG. 1;

FIG. 6 is another schematic of a top view of the portable generator of FIG. 1; and

FIG. 7 is a schematic of a control panel of the portable generator of FIG. 1.

Corresponding reference numerals are used to indicate corresponding parts throughout the several views.

### DETAILED DESCRIPTION

The implementations of the present disclosure described below are not intended to be exhaustive or to limit the disclosure to the precise forms in the following detailed description. Rather, the implementations are chosen and described so that others skilled in the art may appreciate and understand the principles and practices of the present disclosure.

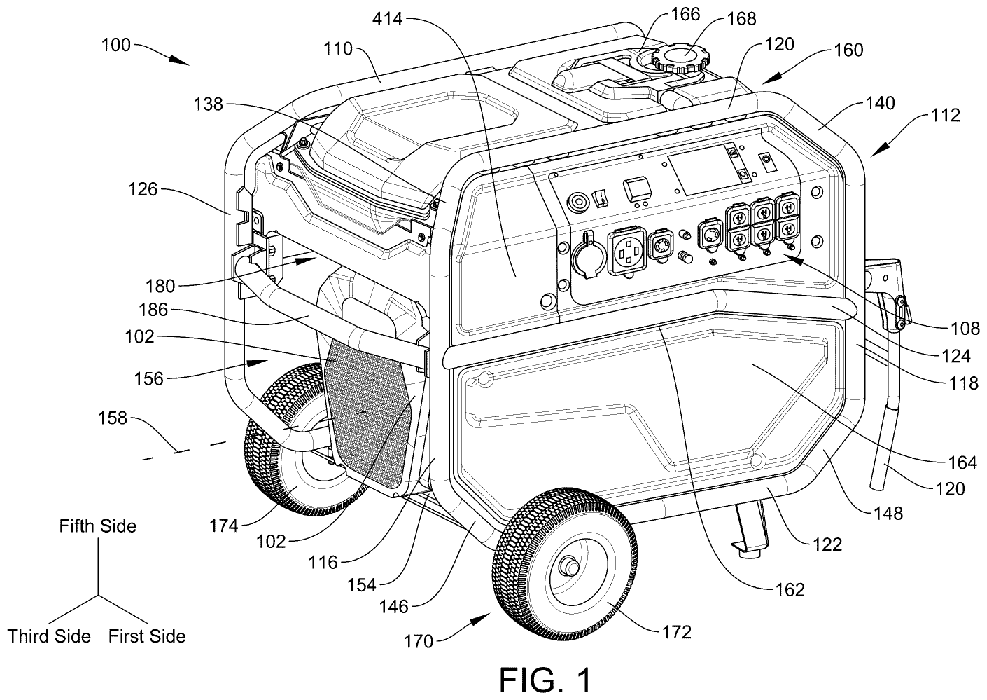

In FIG. 1, one implementation of a portable generator 100 is shown according to the present disclosure. The generator 100 is an open-frame 110 generator 100 configured to generate electric power. The generator 100 may include an engine 102. In some implementations, the engine 102 may be an internal combustion engine 102. In some implementations, the engine 102 may be an electronic fuel injection engine 102.

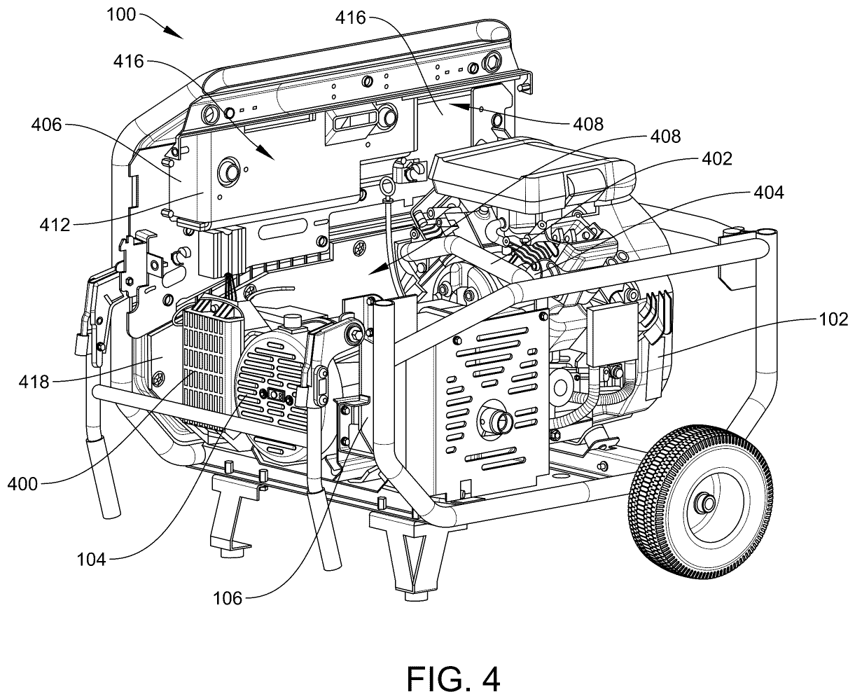

The generator 100 may include an alternator 104 as shown in FIG. 4. The alternator 104 may be operably coupled to the engine 102. In some implementations, the alternator 104 may convert mechanical energy produced by the engine 102 into electrical energy.

The generator 100 may include a battery 160.

The generator 100 may include a muffler 106 fluidly coupled to the engine 102. The muffler 106 helps attenuate sound and improve sound quality produced from the engine 102.

The generator 100 may include a control panel 108 to control the operation of the generator 100 and to provide an interface for electrical connection for the electrical power produced by the generator 100. The generator 100 may include a frame 110 configured to hold different components of the generator 100.

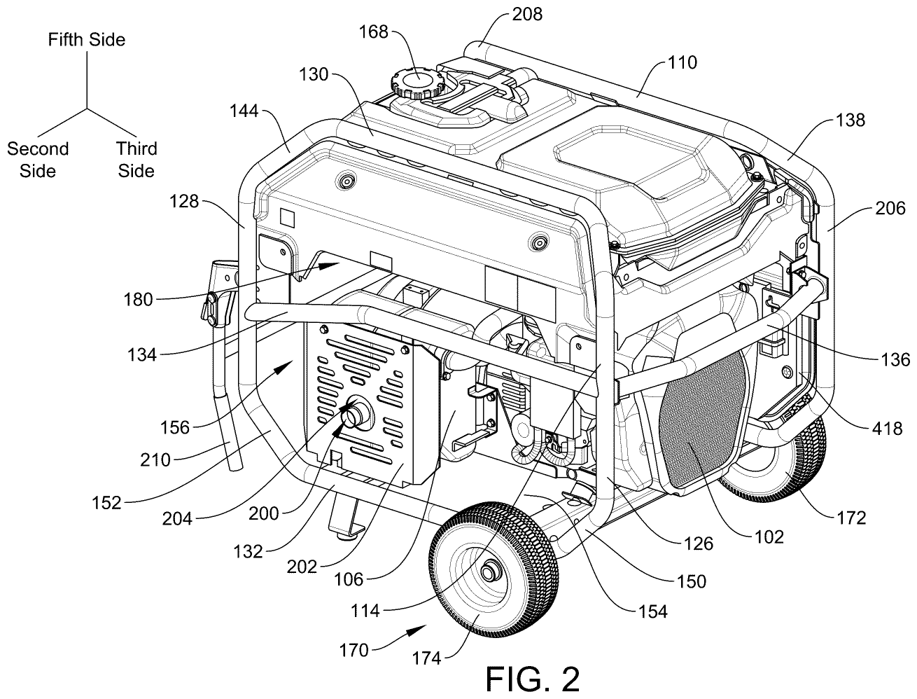

In FIGS. 1-2, the generator 100 is shown in an upright position. The generator 100 may have a first side, a second side, a third side, a fourth side, a fifth side, and a sixth side. In some implementations, there may be more than six sides. In some implementations there may be less than six sides.

The frame 110 may include a first frame unit 112 and a second frame unit 114, the second frame unit 114 spaced opposite the first frame unit 112. In some implementations, the frame 110 may be a generally tubular frame 110. In some implementations, the frame 110 may at least be in part formed by tubing or piping. In some implementations, the frame 110 may be formed in part by tubing or piping with a circular cross section.

The first frame unit 112 may include a first vertical member 116, a second vertical member 118, a first horizontal member 120, and a second horizontal member 122. The first frame unit 112 may include a first crossbar 124. The first crossbar 124 may extend between the first vertical member 116 and the second vertical member 118. In some implementations, the first horizontal member 120, the first vertical member 116, and the second vertical member 118 may define a first plane. The second frame unit 114 may include a third vertical member 126, a fourth vertical member 128, a third horizontal member 130, and a fourth horizontal member 132. The second frame unit 114 may include a second crossbar 134. The second crossbar 134 may extend between the third vertical member 126 and the fourth vertical member 128. In some implementations, the third horizontal member 130, the third vertical member 126, and the fourth vertical member 128 may define a second plane. A third crossbar 136 may extend between the first vertical member 116 and the third vertical member 126.

The first frame unit 112 may further include a first corner member 138 and a second corner member 140. The first horizontal member 120 may be coupled to the first vertical member 116 and the second vertical member 118 with the first corner member 138 and the second corner member 140, respectively. The first corner member 138 may be angled between the first horizontal member 120 and the first vertical member 116. In some implementations, the first corner member 138 may be angled relative to the first plane. Similarly, the second corner member 140 may be angled between the first horizontal member 120 and the second vertical member 118. In some implementations, second corner member 140 may be angled relative to the first plane. As shown in FIG. 1, the first corner member 138 and the second corner member 140 are angled relative to the first plane.

The second frame unit 114 may further include a third corner member 142 and a fourth corner member 144. Similarly, the third horizontal member 130 may be coupled to the third vertical member 126 and the fourth vertical member 128 with the third corner member 142 and the fourth corner member 144, respectively. The third corner member 142 may be angled between the third horizontal member 130 and the third vertical member 126. In some implementations, the third corner member 142 may angled relative to the second plane. Similarly, the fourth corner member 144 may be angled between the third horizontal member 130 and the fourth vertical member 128. In some implementations, the fourth corner member 144 may be angled relative to the second plane. As shown, the third corner member 142 and the fourth corner member 144 are angled relative to the first plane.

The first frame unit 112 may further include fifth corner member 146 and sixth corner member 148. The second horizontal member 122 may be coupled to the first vertical member 116 and the second vertical member 118 with the fifth corner member 146 and sixth corner member 148, respectively. Fifth corner member 146 may be angled between the second horizontal member 122 and the first vertical member 116. In some implementations, the fifth corner member 146 may be aligned in the first plane. Similarly, the sixth corner member 148 may be angled between the second horizontal member 122 and the second vertical member 118. In some implementations, sixth corner member 148 may be aligned in the first plane. As shown in FIG. 1, the fifth corner member 146 and the sixth corner member 148 are aligned in the first plane.

The second frame unit 114 may further include a seventh corner member 150 and an eighth corner member 152. Similarly, the fourth horizontal member 132 may be coupled to the third vertical member 126 and the fourth vertical member 128 with the seventh corner member 150 and the eighth corner member 152, respectively. The seventh corner member 150 may be angled between the fourth horizontal member 132 and the third vertical member 126. In some implementations, the seventh corner member 150 may be aligned in the second plane. Similarly, the eighth corner member 152 may be angled between the fourth horizontal member 132 and the fourth vertical member 128. In some implementations, the eighth corner member 152 may be aligned in the second plane. As shown in FIG. 2, the seventh corner member 150 and the eighth corner member 152 are aligned in the second plane.

In some implementations, the first horizontal member 120, the second horizontal member 122, the first vertical member 116, the second vertical member 118, the first corner member 138, the second corner member 140, the fifth corner member 146 and the sixth corner member 148 may all be formed by one tube. In such an implementation, a tube may be bent to form these members. In some implementations, the first horizontal member 120, the second horizontal member 122, the first vertical member 116, the second vertical member 118, the first corner member 138, the second corner member 140, the fifth corner member 146, and the sixth corner member 148 may all be separate tubes. In such an implementation, these members may be connected together in a configuration as disclosed herein.

Similarly, in some implementations, the third horizontal member 130, the fourth horizontal member 132, the third vertical member 126, the fourth vertical member 128, the third corner member 142, the fourth corner member 144, the seventh corner member 150, and the eighth corner member 152 may all be formed by one tube. In such an implementation, a tube may be bent to form these members. In some implementations, the third horizontal member 130, the fourth horizontal member 132, the third vertical member 126, the fourth vertical member 128, the third corner member 142, the fourth corner member 144, the seventh corner member 150, and the eighth corner member 152 may all be separate tubes. In such an implementation, these members may be connected together in a configuration as disclosed herein.

In several implementations, a front frame member or assembly 206 may be at least partially formed by the first vertical member 116, second vertical member 126, and third crossbar 136. The front frame member or assembly 206 may include at least one front top corner member 208.

The frame 110 may include a base plate 154 coupling the first frame unit 112 and the second frame unit 114. The base plate 154 may extend between the second horizontal member 122 and the fourth horizontal member 132.

The first frame unit 112, the second frame unit 114, and the third crossbar 136 may at least partially form a cage assembly. The cage assembly may define a cavity 156, the cavity 156 located within the cage assembly.

The engine 102 may be coupled to the frame 110. The engine 102 may be positioned inside the cavity 156 of the cage assembly. The frame 110 may contain a plurality of engine 102 mounting points configured to couple the engine 102 to the frame 110. The plurality of engine 102 mounting points may be in the form of brackets positioned on the frame 110. The engine 102 may be coupled to the frame 110 along an axis 158 of the frame 110 extending from the third side to the fourth side. In some implementations, the engine 102 may be coupled to the frame 110 along the axis 158 towards the third side of the generator 100. The engine 102 may be coupled to the frame 110 between the first frame unit 112 and the second frame unit 114. In some implementations, the engine 102 is not in contact with the first frame unit 112, the second frame unit 114, or the third crossbar 136. A space may exist between the engine 102 and the third crossbar 136.

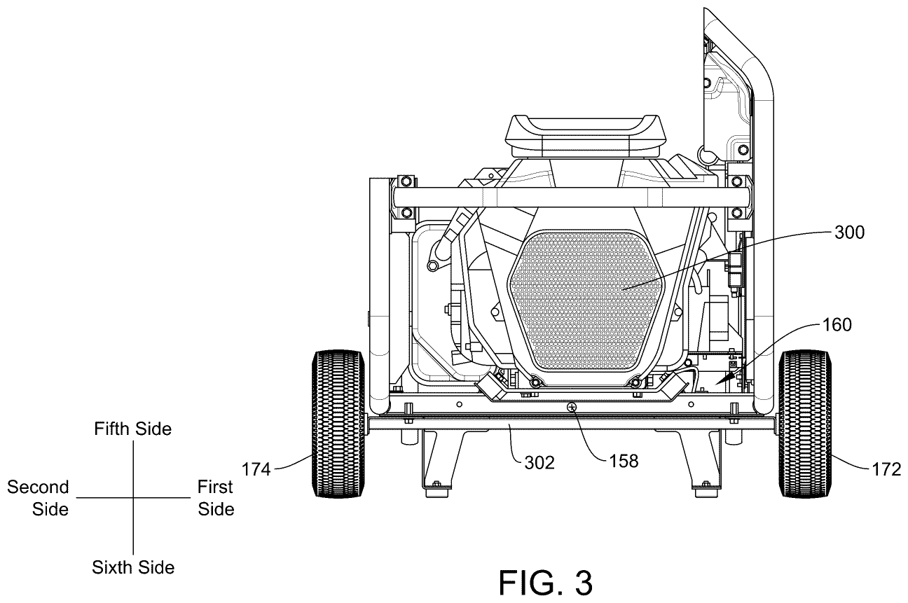

The engine 102 may contain a first air intake 300 configured to intake air to flow through the engine 102. Airflow from the first air intake 300 is able to flow over different components of the engine 102. The airflow allows the heat generated by the engine 102 to be transferred to the airflow and reduce the temperature of the engine 102. The airflow is able to leave the engine 102 and may flow over at least one of the alternator 104, the battery 160, or the muffler 106. As the airflow moves over at least one of the alternator 104, the battery 160, or the muffler 106, the heat from at least one of the alternator 104, the battery 160, or the muffler 106 is transferred to the airflow reducing the temperature of these components. The first air intake 300 may be positioned in a direction allowing it to intake air from outside the generator 100. As shown in FIG. 3, the first air intake 300 is positioned facing the third side of the generator 100.

The alternator 104 may be coupled to the frame 110. The alternator 104 may be positioned inside the cavity 156 of the cage assembly. The frame 110 may contain a plurality of alternator 104 mounting points configured to couple the alternator 104 to the frame 110. The plurality of alternator 104 mounting points may be in the form of brackets positioned on the frame 110. The alternator 104 may be coupled to the frame 110 along the axis 158 of the frame 110. In some implementations, the alternator 104 may be coupled to the frame 110 along the axis 158 towards the fourth side of the generator 100. Positioning the alternator 104 along the axis 158 with the engine 102 allows the alternator 104 to use the mechanical energy produced by the engine 102 and convert it into electrical power. In some implementations, the alternator 104 is directly and operably coupled to the engine 102.

The alternator 104 may include a second air intake 400. The second air intake 400 is positioned towards a side of the generator 100. In some implementations, the second air intake 400 is positioned facing in a direction opposite the first air intake 300. As shown in FIG. 4, the second air intake 400 is positioned facing the fourth side. The second air intake 400 is configured to intake air from the direction the second air intake 400 is facing and move that air through the alternator 104. Some of the heat generated by the alternator 104 is then transferred to this air as it flows through the alternator 104 reducing the temperature of the alternator 104. The air is then expelled out of the alternator 104 and is able to flow across at least one of the muffler 106 or the battery 160. Similarly as described with the airflow from the first air intake 300, the expelled air from the second air intake 400 is able to flow across at least one of the muffler 106 or the battery 160 allowing heat generated by these components to be transferred to the expelled air reducing the temperature of at least one of the muffler 106 or the battery 160.

The battery 160 may be coupled to the frame 110. The battery 160 may be positioned inside of the cavity 156 of the cage assembly. The battery 160 may be coupled towards the first side of the generator 100. The battery 160 may be coupled towards the fourth side of the generator 100. In some implementations, the battery 160 may be positioned at the corner formed by the first side, the fourth side, and the sixth side of the generator 100. In some implementations where both the engine 102 and the alternator 104 are coupled along the axis 158 of the frame 110, positioning the battery 160 in the corner formed by the first side, the fourth side, and the sixth side of the generator 100 allows for the airflow and the expelled air to reduce the temperature of the battery 160.

The muffler 106 may be coupled to the frame 110. The muffler 106 may be positioned inside of the cavity 156 of the cage assembly. The frame 110 may contain a plurality of muffler 106 mounting points. In some implementations, the plurality of muffler 106 mounting points may be in the form of brackets. The plurality of muffler 106 mounting points is configured to couple the muffler 106 to the frame 110 of the generator 100. The muffler 106 may be fluidly connected to the engine 102. More specifically, the muffler 106 may be fluidly connected to one or more exhaust ports of the engine 102. In some implementations, one or more header pipes may fluidly connect the one or more exhaust ports of the engine 102. As shown in FIG. 4, a first header pipe 402 fluidly couples a first exhaust port of the engine 102 to the muffler 106. A second header pipe 404 fluidly couples a second exhaust port of the engine 102 to the muffler 106. Exhaust from the engine 102 is able to travel through the one or more header pipes and into the muffler 106. The exhaust is then able to exit the muffler 106 through an outlet 200. The outlet 200 may be positioned facing a side of the generator 100 that is different from the first air intake 300 and the second air intake 400. Positioning the outlet 200 facing a side of the generator 100 that is different from the first air intake 300 and the second air intake 400 reduces ingress of exhaust from the outlet 200 to the first air intake 300 and the second air intake 400. As shown in FIG. 2, the outlet 200 may be positioned facing the second side of the generator 100.

The generator 100 may include an exhaust cover 202. The exhaust cover 202 may be coupled to the frame 110. The exhaust cover 202 is configured to reduce the chance of a user contacting the muffler 106. The exhaust cover 202 may include a cover orifice 204. The cover orifice 204 may be aligned with the outlet 200 of the muffler 106. The cover orifice 204 allows for the outlet 200 of the muffler 106 to not be obstructed by the exhaust cover 202. In some implementations, the outlet 200 of the muffler 106 may extend through the cover orifice 204.

One or more of the sides of the generator 100 may be enclosed. Enclosing one or more of the sides helps to reduce the noise level that a user may experience. As shown in FIGS. 1-4, the first side and the fifth side of the generator 100 are at least partially enclosed and will be discussed in further detail below.

The generator 100 may include a side panel 162. The side panel 162 may comprise the control panel 108. The side panel 162 may be coupled to the frame 110. As shown in FIG. 1, the side panel 162 is coupled to the first side of the generator 100. The side panel 162 may be positioned inside the cavity 156 of the cage assembly. The side panel 162 is configured to enclose one of the sides of the generator 100.

The control panel 108 may be coupled to the side panel 162. The control panel 108 may be positioned inside the cavity 156 of the cage assembly. In some implementations, the control panel 108 may be coupled to cover at least part of one side of the generator 100 between the first horizontal member 120 and first crossbar 124 at least partially enclosing part of one of the sides of the generator 100. Positioning the control panel 108 between the first horizontal member 120 and the first crossbar 124 allows the user to interact with the control panel 108 easier than if it was positioned towards the second horizontal member 122. In some implementations, the control panel 108 may be coupled to the first horizontal member 120, the second vertical member 118, and the first crossbar 124. As shown in FIG. 1, the control panel 108 is coupled to the side panel 162 to cover at least part of the first side between the first horizontal member 120, the second vertical member 118, and the first crossbar 124. Positioning the control panel 108 here increases the distance between the control panel 108 and the engine 102. By increasing the distance between the control panel 108 and the engine 102, less heat is being transferred from the engine 102 to the control panel 108 reducing the temperature of the control panel 108. The control panel 108 may be coupled to the side panel 162 in other positions. In some implementations, the control panel 108 may be directly coupled to the frame 110.

The side panel 162 may include control panel 108 foam coupled to a housing 406 of the control panel 108. The control panel 108 foam may be positioned in the cavity 156 of the cage assembly. In some implementations, the control panel 108 foam may be sound attenuating foam 408. Advantageously, having the control panel 108 foam coupled to the housing 406 of the control panel 108 helps reduce the noise an operator experiences when using the generator 100. Positioning the control panel 108 foam on the housing 406 allows the control panel 108 foam to at least partially absorb the soundwaves released by at least one of the engine 102, the alternator 104, or the muffler 106. By absorbing some of the sound waves produced by at least one of the engine 102, the alternator 104, or the muffler 106, less sound waves are able to travel to the user making a lower sound level for the user. The control panel 108 foam may be at least partially wrapped in foil 412. Advantageously, having the control panel 108 foam at least partially wrapped in foil 412 helps reflect heat generated by at least one of the engine 102, the alternator 104, the battery 160, or the muffler 106 and ultimately reducing the heat transfer from at least one of the engine 102, the alternator 104, the battery 160, or the muffler 106 to the control panel 108.

The side panel 162 may include a filler panel 414. The filler panel 414 may be coupled to the side panel 162. The filler panel 414 may be positioned inside the cavity 156 of the cage assembly. The filler panel 414 helps to cover part of the side of the generator 100 that the cover panel 164 is coupled to partially enclose one side of the generator 100. In some implementations, the filler panel 414 is coupled to the side panel 162 to fill an aperture of the first side of the generator 100 not covered by the control panel 108. As shown in FIG. 4, the filler panel 414 is coupled to the side panel 162, specifically coupled to cover part of the first side between the first horizontal member 120, the first vertical member 116, and the first crossbar 124. The filler panel 414 helps to at least partially deflect the sound waves produced by the at least one of the engine 102, alternator 104, the battery 160, or the muffler 106 away from a user. In some implementations where the filler panel 414 is coupled to the first side of the generator 100, the sound waves generated by at least one of the engine 102, alternator 104, the battery 160, or the muffler 106 are at least partially deflected away from the first side.

The side panel 162 may include filler panel foam 416. The filler panel foam 416 may be positioned in the cavity 156 of the cage assembly. The filler panel foam 416 helps absorb some the sound waves generated by the at least one of the engine 102, alternator 104, or the muffler 106. In some implementations, the filler panel foam 416 may be sound attenuating foam 408. By absorbing some of the sound waves, less sound waves are able to travel to the user making a lower sound level for the user. The filler panel foam 416 may be coupled to the filler panel 414. In some implementations, the filler panel foam 416 is coupled to a first surface of the filler panel 414. In some implementations where the filler panel 414 is coupled to the first side of the generator 100, the sound waves generated by the at least one of the engine 102, alternator 104, or the muffler 106 are at least partially absorbed by the filler panel foam 416 reducing the amount of sound waves traveling to the first side of the generator 100. By positioning the filler panel 414 near the engine 102, the filler panel foam 416 is able to absorb sound waves generated by the engine 102 quicker than if the filler panel 414 was positioned further away from the engine 102. Absorbing more of the sound waves quicker from the engine 102 helps reduce the chance of sound waves deflecting off of at least one of the engine 102, alternator 104, the battery 160, or the muffler 106 and not being absorbed by the filler panel foam 416.

The side panel 162 may include a cover panel 164. The cover panel 164 may be coupled to the frame 110. The cover panel 164 may be positioned in the cavity 156 of the cage assembly. The cover panel 164 helps to cover part of the side of the generator 100 that the cover panel 164 is coupled to at least partially enclose one side of the generator 100. In some implementations, the cover panel 164 is coupled to the side panel 162 to fill a gap produced by the frame 110 on one of the sides of the generator 100. As shown in FIG. 1, the cover panel 164 is coupled to the side panel 162, specifically coupled to cover the first side between the first crossbar 124, the second horizontal member 122, the first vertical member 116 and the second vertical member 118. The cover panel 164 helps to at least partially deflect the sound waves produced by the at least one of the engine 102, alternator 104, or the muffler 106 away from a user. In some implementations where the cover panel 164 is coupled to the first side of the generator 100, the sound waves generated by at least one of the engine 102, alternator 104, or the muffler 106 are at least partially deflected away from the first side.

The side panel 162 may include cover panel foam 418. The cover panel foam 418 helps absorb some the sound waves generated by at least one of the engine 102, alternator 104, or the muffler 106. By absorbing some of the sound waves, less sound waves are able to travel to the user making a lower sound level for the user. In some implementations, the cover panel foam 418 may be sound attenuating foam 408. The cover panel foam 418 may be coupled to the cover panel 164. In some implementations, the cover panel foam 418 is couple to a first surface of the cover panel 164. The cover panel foam 418 may be the same shape as the cover panel 164. The cover panel foam 418 may cover the first surface of the cover panel 164. In some implementations where the cover panel 164 is coupled to the first side of the generator 100, the sound waves generated by at least one of the engine 102, alternator 104, or the muffler 106 are at least partially absorbed by the cover panel foam 418 reducing the amount of sound waves traveling to the first side of the generator 100. By positioning the cover panel 164 near the engine 102, the cover panel foam 418 is able to absorb sound waves generated by the engine 102 quicker than if the cover panel 164 was positioned further away from the engine 102. Absorbing more of the sound waves quicker from the engine 102 helps reduce the chance of sound waves deflecting off of at least one of the engine 102, alternator 104, the battery 160, or the muffler 106 and not contacting the cover panel foam 418.

The generator 100 may include a fuel tank 166. The fuel tank 166 may be positioned inside of the cavity 156 of the cage assembly. The fuel tank 166 may be fluidly coupled to the engine 102. The fuel tank 166 is configured to hold fuel that may be supplied to the engine 102. The fuel tank 166 may be coupled to the frame 110. In some implementations, the fuel tank 166 may at least partially enclose the fifth side of the generator 100. In some implementations, the fuel tank 166 may at least partially be positioned above the engine 102. In some implementations, the fuel tank 166 may at least partially be positioned above the alternator 104. In some implementations, the fuel tank 166 may at least partially be positioned above the battery 160. In some implementations, the fuel tank 166 may at least partially be positioned above the muffler 106. As shown in the Figures, the fuel tank 166 is at least partially positioned above the engine 102, the alternator 104, the battery 160, and the muffler 106. Positioning the fuel tank 166 at least partially above the engine 102, alternator 104, the battery 160, or the muffler 106 components helps deflecting the sound waves from the other components of the generator 100. When the fuel tank 166 is positioned at least partially above the engine 102, alternator 104, the battery 160, or the muffler 106 and at least partially defining the fifth side of the generator 100, the sound waves from the other components of the generator 100 are at least partially deflected in a direction away from the fifth side of the generator 100. Deflecting at least some of the sound waves away from the fifth side of the generator 100 helps reduce the amount of sound waves produced from the at least one of the engine 102, alternator 104, or the muffler 106 to the fifth side of the generator 100 and thus reducing the noise level that a user may experience. Some of the sound waves that are deflected from the fuel tank 166 may be absorbed by the control panel 108 foam, the filler panel foam 416, and/or the cover panel foam 418.

The fuel tank 166 may include a fuel inlet. The fuel inlet may be in the form of an orifice fluidly coupled to a cavity 156 of the fuel tank 166. The fuel inlet may be positioned on a first outer surface of the fuel tank 166. The fuel tank 166 may include a cap 168 to fluidly seal the fuel inlet, as shown in FIG. 1.

The generator 100 may include a heat shield 180. The heat shield 180 may be coupled to the frame 110. The heat shield 180 may be positioned in the cavity 156 of the cage assembly. The heat shield 180 may be positioned between the engine 102 and the fuel tank 166. The heat shield 180 may be positioned between the alternator 104 and the fuel tank 166. The heat shield 180 may be positioned between the muffler 106 and the fuel tank 166. The heat shield 180 may be positioned between the battery 160 and the fuel tank 166. In some implementations, the heat shield 180 is positioned creating a gap between the fuel tank 166 and the heatshield. In some implementations, the heat shield 180 may be positioned a half an inch below a second outer surface of the fuel tank 166. In some implementations, the heat shield 180 may be positioned at a distance greater than or less than a half an inch. The heat shield 180 helps reduce the amount of heat transferred to the fuel tank 166. Reducing the amount of heat transferred to the fuel tank 166 helps keep the temperature of the fuel tank 166 and the fuel itself cooler. Additionally, the heat shield 180 helps control the airflow and the expelled air. In some implementations, the airflow and the expelled air may deflect off of the heat shield 180 and contact at least one of the engine 102, alternator 104, the battery 160, or the muffler 106. As mentioned above, having the airflow and expelled air contact the components of the generator 100 helps to control the temperature of at least one of the engine 102, alternator 104, the battery 160, or the muffler 106.

In some implementations, the heat shield 180 may be formed out of steel. More specifically, the heat shield 180 may be formed from 18-gauge steel. In some implementations, the heat shield 180 may generally be the same shape as the second outer surface of the fuel tank 166. In other implementations, the heat shield 180 may not be the same shape as the second outer surface of the fuel tank 166.

In some implementations, the engine 102 may be coupled to the frame 110 inside the cavity 156 of the cage assembly towards the third side of the generator 100. The alternator 104 may be operably coupled to engine 102 and positioned towards the fourth side of the generator 100 relative to the engine 102. The battery 160 may be positioned adjacent the alternator 104 towards the first side of the generator 100 relative to the alternator 104. The muffler 106 may be fluidly coupled to the engine 102 and positioned adjacent the alternator 104 towards the second side of the generator 100 relative to the alternator 104. The side panel 162 may be coupled to the frame 110 and enclosing the first side of the generator 100. The side panel 162 may have foam attached to the side panel 162. The foam may be positioned between the first surface of the side panel 162 and at least one of the engine 102, the alternator 104, the battery 160, or the muffler 106. The side panel 162 may include a control panel 108. The control panel 108 may have control panel 108 foam coupled to the housing 406 of the control panel 108. The control panel 108 foam may be at least partially wrapped in foil 412. The fuel tank 166 may be fluidly coupled to the engine 102 and positioned at least partially above the engine 102, the alternator 104, the battery 160, and the muffler 106 towards the fifth side of the generator 100. The heat shield 180 may be coupled to the frame 110 and positioned between the fuel tank 166 and the engine 102, the alternator 104, the battery 160, and the muffler 106.

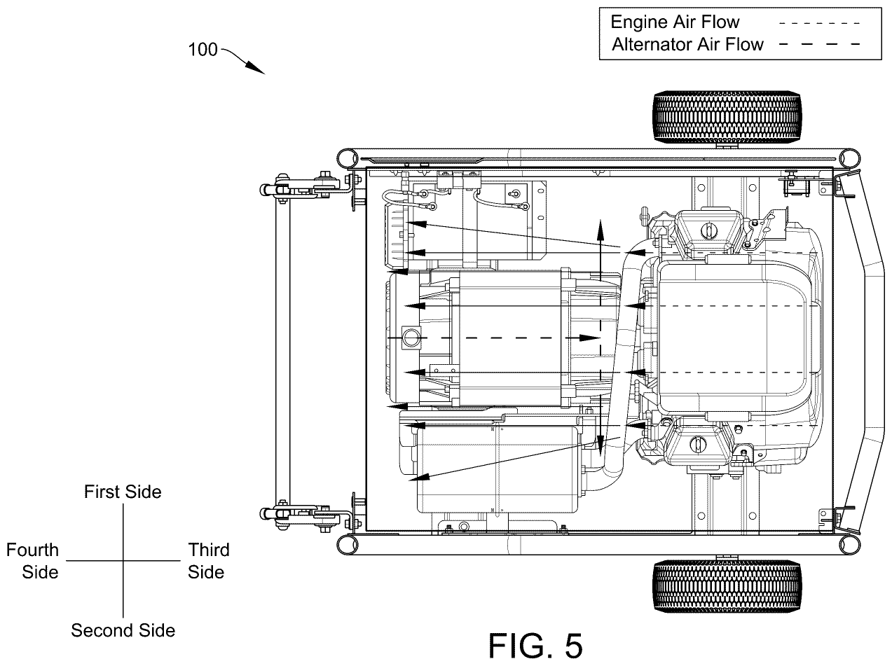

In some implementations, the cavity 156 inside the cage assembly may at least be partially filled by at least one of the engine 102, the alternator 104, the battery 160, the muffler 106, the side panel 162, or the fuel tank 166. In some implementations, the cavity 156 inside the cage assembly may not be completely filled by at least one of the engine 102, the alternator 104, the battery 160, the muffler 106, the side panel 162, or the fuel tank 166. Not allowing the cavity 156 inside the cage assembly to be completely filled may allow at least the airflow or the expelled air to escape out at least one of the sides of the generator 100 easier. Allowing at least the airflow or the expelled air to escape out at least one of the sides of the generator 100 allows for better heat transfer from at least one of the engine 102, the alternator 104, the battery 160, the muffler 106, or the heat shield 180. As shown in FIG. 4, some of the cavity 156 inside the cage assembly above the alternator 104, the battery 160, and the muffler 106 is not filled. This allows for the airflow from the engine 102 to escape out at least second side or the fourth side easier, as shown in FIG. 5. Additionally, by not filling the cavity 156 inside the cage above the alternator 104, the battery 160, and the muffler 106 creates a larger distance from the heat shield 180 and the fuel tank 166 which reduces the heat transferred from the alternator 104, the battery 160, and the muffler 106 to the heat shield 180 and the fuel tank 166.

In some implementations, the cage assembly may surround the engine 102, the alternator 104, the battery 160, the muffler 106, the fuel tank 166, and the side panel 162. Having the cage assembly surround the engine 102, the alternator 104, the battery 160, the muffler 106, the fuel tank 166, and the side panel 162 helps protect these parts in the event the generator 100 gets flipped in a position other than its upright position.

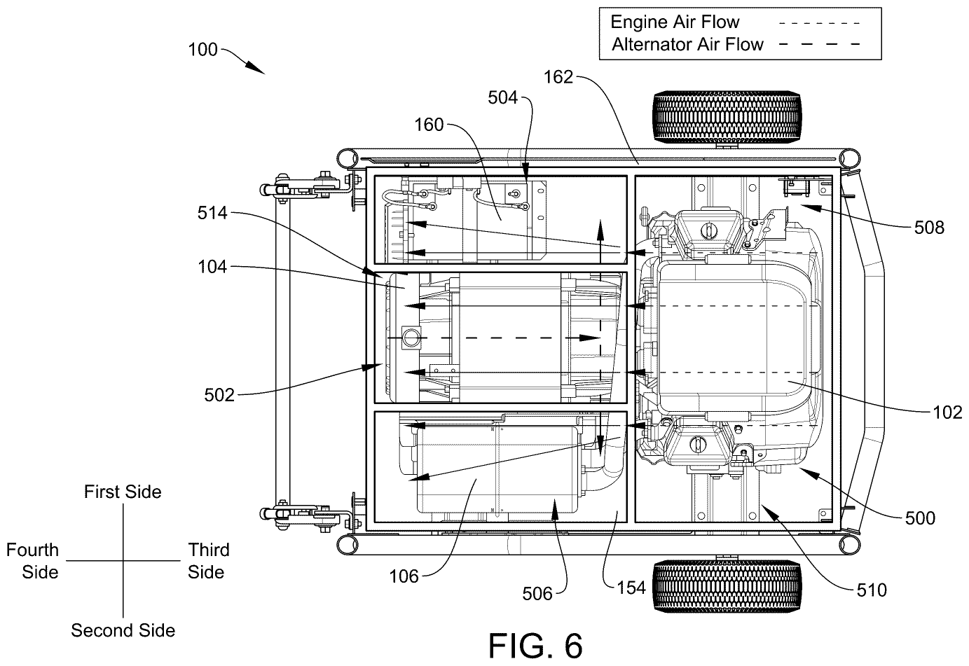

Referring to FIG. 6, the cavity 156 may define a first region 500. The engine 102 may be positioned in the first region 500. The first region 500 may be towards the third side of the generator 100. The first region 500 may extend from the sixth side of the generator 100 and the heat shield 180. A first side gap 510 may exist in the first region 500. The first side gap 510 may be the space between the engine 102 and the side panel 162. A second side gap 512 may exist in the first region 500. The second side gap 512 may be the space between the engine 102 and the second side of the generator 100.

The cavity 156 may define a second region 502. The alternator 104 may positioned in the second region 502. The second region 502 may be towards the fourth side of the generator 100. The second region 502 may be adjacent the first region 500 and between the fourth side and the first region 500. The second region 502 may extend from the sixth side of the generator 100 to the heat shield 180. A second region gap 514 may exist in the second region 502. The second region gap 514 may be the space between the alternator 104 and the heat shield 180.

The cavity 156 may define a third region 504. The battery 160 may be positioned in the third region 504. The third region 504 may be towards the fourth side and the first side of the generator 100. The third region 504 may be adjacent the second region 502 and between the first side of the generator 100 and the second region 502. The third region 504 may extend from the sixth side of the generator 100 to heat shield 180. A third region 504 gap may exist in the third region 504. The third region 504 gap may be at least partially defined as the space between the battery 160 and the heat shield 180. In some implementations, the third region 504 gap may be at least partially defined by the space between the base plate 154 and the heat shield 180 in the third region 504.

The cavity 156 may define a fourth region 506. The muffler 106 may be positioned in the fourth region 506. The fourth region 506 may be towards the fourth side and the second side of the generator 100. The fourth region 506 may be adjacent the second region 502 and between the second side of the generator 100 and second region 502. The fourth region 506 may extend from the sixth side of the generator 100 to the heat shield 180. A fourth region 506 gap may exist in the fourth region 506. The fourth region 506 gap may at least be partially defined as the space between the muffler 106 and the heat shield 180. In some implementations, the fourth region 506 gap may be at least partially defined as the space between the base plate 154 and the heat shield 180 in the fourth region 506.

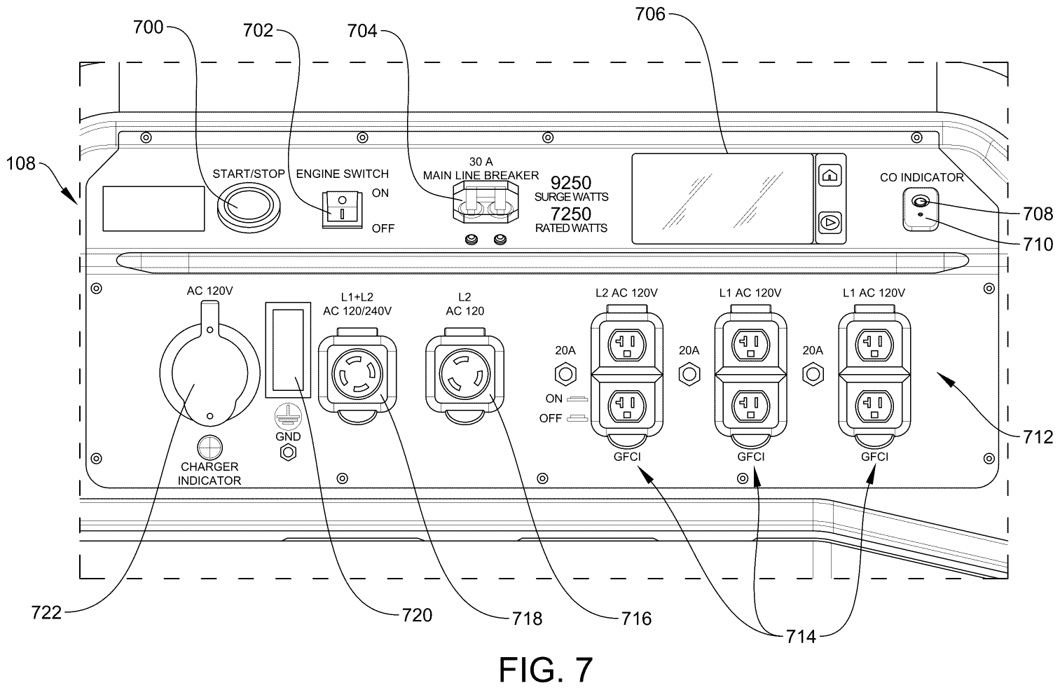

Referring now to FIG. 7, the control panel 108 may contain a starting mechanism 700. The starting mechanism 700 is configured to start the engine 102 allowing it to run and stop the engine 102 from running. The starting mechanism 700 may be in the form of a push button. The starting mechanism 700 may be in a form other than a push button such as a knob, a switch, a lever, a pull cord, or other control.

The control panel 108 may contain an engine switch 702. The engine switch 702 is configured to shut off the engine 102 when turned to an off position.

The control panel 108 may include a main line breaker 704. The main line breaker 704 is configured to monitor the total electrical load on the system. The main line breaker 704 is configured to protect the engine 102, the alternator 104, wires of the control panel 108, and potentially appliances that may be plugged into the generator 100.

The control panel 108 may include a visual display 706 for displaying information about the generator 100, performance metrics, diagnostics, maintenance reminders, instructions, etc. The control panel 108 may include a carbon monoxide (CO) sensor. The carbon monoxide sensor may be placed near the engine 102 and configured to monitor CO levels. The control panel 108 may include a carbon monoxide (CO) indicator 708. If the CO sensor detects a threshold level of CO, the CO indicator 708 may activate. When activated, the CO indicator 708 may shut off the engine 102 and not allow the generator 100 to produce more carbon monoxide. An indicator light 710 may illuminate notifying the user that the threshold level was experienced.

A plurality of electrical outlets 712 may include one or more ground fault circuit interrupter (GFCI) outlets 714. The one or more GFCI outlets 714 may be 120 volt, 20 amp outlets. The plurality of electrical outlets 712 may include a 120 volt, 30 amp outlet 716. The control panel 108 may include a 120/240 volt, 30 amp outlet 718. The plurality of electrical outlets 712 may include a 240 volt, 60 amp outlet 720.

The control panel 108 may include a charging port 722. The charging port 722 is configured to allow electrical connection to the charger port 722 to charge the battery 160. This is beneficial where the generator 100 is not in use to provide a charge to the battery 160.

The generator 100 may be transportably supported by a wheel assembly 170. The wheel assembly 170 may be coupled to the frame 110. In some implementations the wheel assembly 170 may contain an axle 302 coupled to the frame 110. In some implementations the wheel assembly 170 may contain two wheels coupled to the frame 110. In some implementation, the wheel assembly 170 may be coupled to the frame 110 at a location below the engine 102. Coupling the wheel assembly 170 to the frame 110 in a position below the engine 102 reduces the force required to lift the side of the generator 100 positioned away from the wheel assembly 170. As shown in FIG. 1, the wheel assembly 170 is coupled below the engine 102 near the third side which reduces the force required to lift the fourth side when transporting the generator 100 via the wheel assembly 170. A first wheel 172 is coupled to the axle 302 at the first side of the generator 100. A second wheel 174 is coupled to the axle 302 at the second side of the generator 100. In some implementations the wheel assembly 170 may be positioned away from the muffler 106. Positioning the wheel assembly 170 away from the muffler 106 reduces the heat generated by the muffler 106 from contacting the wheel assembly 170. Reducing the heat generated by the muffler 106 from contacting the wheel assembly 170 reduces the chances of the wheel assembly 170 deforming or melting from the heat.

The frame 110 may include a handle assembly 210. The handle assembly 210 may be coupled to the frame 110. As shown in FIG. 2, the handle assembly 210 is coupled to the fourth side of the generator 100. The handle assembly 210 may be rotatably coupled to the frame 110. The frame 110 may include handle assembly 210 mounts configured to rotatably couple the handle assembly 210 to the frame 110. The handle assembly 210 mounts may be in the form of brackets.

While the disclosure has been illustrated and described in detail in the drawings and foregoing description, such illustration and description is to be considered as exemplary and not restrictive in character, it being understood that illustrative implementation(s) have been shown and described and that all changes and modifications that come within the spirit of the disclosure are desired to be protected. It will be noted that alternative implementations of the present disclosure may not include all of the features described yet still benefit from at least some of the advantages of such features. Those of ordinary skill in the art may readily devise their own implementations that incorporate one or more of the features of the present disclosure and fall within the spirit and scope of the present disclosure as defined by the appended claims.

1. A generator comprising:
a frame formed by a plurality of sides including at least a first side, a second side, a third side, and a fourth side;
an engine coupled to the frame;
an alternator operably coupled to the engine;
a muffler fluidly connected to an exhaust of the engine;
a panel coupled to the frame, the panel enclosing the first side of the plurality of sides of the frame, where at least one of the second side, third side, and fourth side are open to a surround environment; and
foam coupled to the panel, the foam positioned between the panel and the engine.

2. The generator of claim 1, where in the foam is sound attenuating foam.

3. The generator of claim 1, wherein the panel comprises a control panel configured to control the operation of the generator.

4. The generator of claim 3, wherein control panel foam is coupled to a housing of the control panel, the control panel foam configured to separate the control panel from at least the engine.

5. The generator of claim 4, wherein the control panel foam is at least partially wrapped in foil.

6. The generator of claim 3, further comprising a battery electrically coupled to the control panel.

7. The generator of claim 1, further comprising a fuel tank fluidly coupled to the engine.

8. The generator of claim 7, wherein the fuel tank at least partially encloses the second side of the plurality of sides.

9. The generator of claim 1, wherein the frame comprises a first frame unit, a second frame unit, and a crossbar, the crossbar being coupled between the first frame unit and the second frame unit.

10. The generator of claim 9, wherein the first frame unit comprises at least a first horizontal member, a second horizontal member, a first vertical member, a second vertical member, and a first crossbar;
wherein, the second frame unit comprises at least a third horizontal member, a fourth horizontal member, a third vertical member, a fourth vertical member, and a second crossbar.

11. The generator of claim 9, wherein the first frame unit is formed in a first plane and the second frame unit is formed in a second plane, where the first plane and second plane are generally parallel to one another.

12. The generator of claim 9, wherein the panel is coupled to either the first frame unit or the second frame unit.

13. The generator of claim 12, wherein the panel comprises a side panel, a cover panel, and a filler panel.

14. The generator of claim 13, wherein the panel comprises an internal side and an exterior side, where the foam is coupled to the internal side of the panel.

15. A portable generator configured for generating electrical power, comprising:
a frame formed by a plurality of sides including at least a first side, a second side, a third side, and a fourth side of the frame;
an internal cavity defined by the frame, the internal cavity forming at least a first region, a second region, a third region, and a fourth region;
an engine coupled to the frame and located in the first region;
an alternator operably coupled to the engine, the alternator located in the second region;
a muffler fluidly connected to an exhaust of the engine, the muffler located in the third region;
a battery electrically coupled to a control panel, the battery located in the fourth region;
a panel coupled to the frame, the panel enclosing the first side of the plurality of sides of the frame, where at least one of the second side, third side, and fourth side is open to a surrounding environment; and
foam coupled to the panel, wherein at least a portion of the foam is positioned between the panel and the engine, the alternator, the battery, and the muffler;
wherein, the first region is disposed near the second side of the frame and the second region is disposed near the third side of the frame, where the second side is located on an end of the frame opposite the third side.

16. The portable generator of claim 15, wherein the third region is located adjacent the first side of the frame and the fourth region is located adjacent the fourth side of the frame, the first side being opposite the fourth side.

17. The portable generator of claim 15, further comprising a heat shield disposed between the control panel and the engine.

18. The portable generator of claim 15, wherein the frame comprises a first frame unit, a second frame unit, and a crossbar, the crossbar being coupled between the first frame unit and the second frame unit.
wherein, the first frame unit comprises at least a first horizontal member, a second horizontal member, a first vertical member, a second vertical member, and a first crossbar;
wherein, the second frame unit comprises at least a third horizontal member, a fourth horizontal member, a third vertical member, a fourth vertical member, and a second crossbar.

19. A portable generator configured for generating electrical power, comprising:
a frame formed by a plurality of sides including at least a first side, a second side, a third side, and a fourth side of the frame;
a wheel assembly coupled to the frame, the wheel assembly including one or more wheels;
an internal cavity defined by the frame;
an engine coupled to the frame and configured to produce mechanical power;
an alternator operably coupled to the engine;
a muffler fluidly connected to an exhaust of the engine;
a panel coupled to the frame, the panel enclosing the first side of the plurality of sides of the frame; and
foam coupled to the panel, wherein at least a portion of the foam is positioned between the panel and the engine;
wherein, the panel comprises a side panel, a cover panel, and a filler panel;
wherein, the foam comprises a control panel foam, a filler panel foam, and a cover panel foam;
wherein, at least one of the second side, third side, and fourth side is open to a surrounding environment.

20. The portable generator of claim 19, further comprising a control panel coupled to the frame, the control panel comprising:
a starting mechanism configured to start the engine;
a display configured to display information about the generator;
a plurality of electrical outlets; and
a charging port;
wherein, the control panel is electrically coupled to a battery, the battery being located within the internal cavity of the frame.
